(19) United States
(12) Patent Application Publication
(10) Pub. No.: US 2023/0074755 A1
(43) Pub. Date: Mar. 9, 2023

(54) MASK WITH MICROPHONE ACCESS

(71) Applicant: Phillip Salsedo, Modesto, CA (US)

(72) Inventor: Phillip Salsedo, Modesto, CA (US)

(21) Appl. No.: 17/468,679

(22) Filed: Sep. 8, 2021

(51) Int. Cl. A62B 18/08; A41D 13/11; A41D 1/00; A41D 27/20

(52) U.S. Cl. CPC A62B 18/08; A41D 13/11; A41D 1/002; A41D 27/205

(57) ABSTRACT

An illustrated view of an exemplary improved mask for allowing clearer voice communication is presented. The mask is useful for providing clearer voice communication when the mask is being worn. Also, the mask is useful preventing the spread of infectious diseases such as COVID. The mask further is light-weight, comfortable and cost efficient.

### FIELD OF THE INVENTION

This invention relates to masks. More particularly, it relates to improving the clarity of voice communication when wearing a mask.

### BACKGROUND

The ongoing COVID-19 pandemic was confirmed to have reached the United States in January 2020. The first confirmed case of local transmission was recorded in January, while the first known deaths happened in February. By the end of March, cases had occurred in all 50 U.S. states, the District of Columbia, and all inhabited U.S. territories except American Samoa. As of Jun. 24, 2020, the U.S. had the most confirmed active cases and deaths in the world. As of Jul. 16, 2020, its death rate was 419 per million people, the seventh-highest rate globally.

The Center for Disease Control (CDC) has issued a recommendation to the US population for prevention of contracting COVID 19 as well as other infectious diseases. Those recommendations are: 1) wash hands often; 2) avoid close contact (social distancing); 3) cover mouth and nose with a cloth face cover when around others; 4) cover cough or sneezes; 5) dean and disinfect; and 6) monitor your health daily.

A protective mask, an item of personal protective equipment (PPE), aims to protect a person from potentially infectious materials by covering the nose and mouth of the person from airborne viruses. With the recent CDC guidelines for COVID-19 pandemic, many have turned to masks that cover at least a part of their face, in particular their nose and mouth, Protective masks are pieces of a kit or equipment worn on the head and face to afford protection to the wearer, and today usually have these functions: providing a supply of air or filtering the outside air (respirators and dust masks).

Although protective masks are important and should (must) be worn to protect not only the person wearing the protective mask but also those around them.

Voice communication is often difficult for the receiving party to understand. The mask muffles the sound of the voice or can make it inaudible. When a person needs to speak, they remove their masks. This is a problem as removing of the masks in and/or around others falls outside of the recommendations of the CDC and can promote spreading of infectious diseases such as COVID-19.

Accordingly, and in light of the foregoing, it would be desirable to devise an improved mask that has a pocket or other such mechanism to hold a microphone such that when a person needs to speak the mask is not required to be removed to understand the person. It would be further advantageous if the improved mask were more comfortable, cost effective, water proof and light-weight.

### BRIEF DESCRIPTION OF THE DRAWINGS

FIG. 1A is an illustrated view of an exemplary improved mask.

FIG. 1B is an illustrated view of a microphone for the improved mask shown in FIG. 1A.

FIG. 1C is an illustrated view of an inside of the improved mask shown in FIG. 1A.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

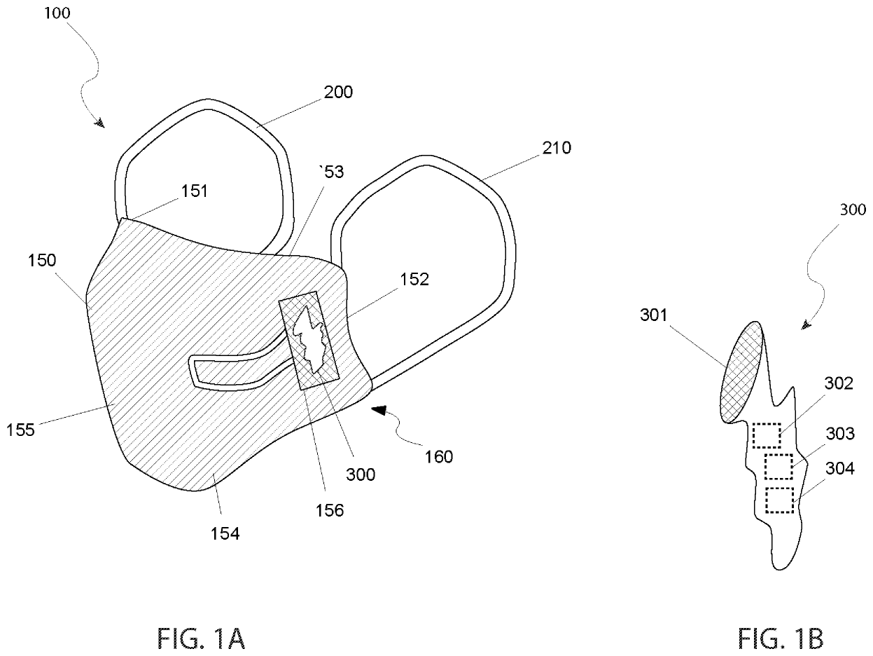

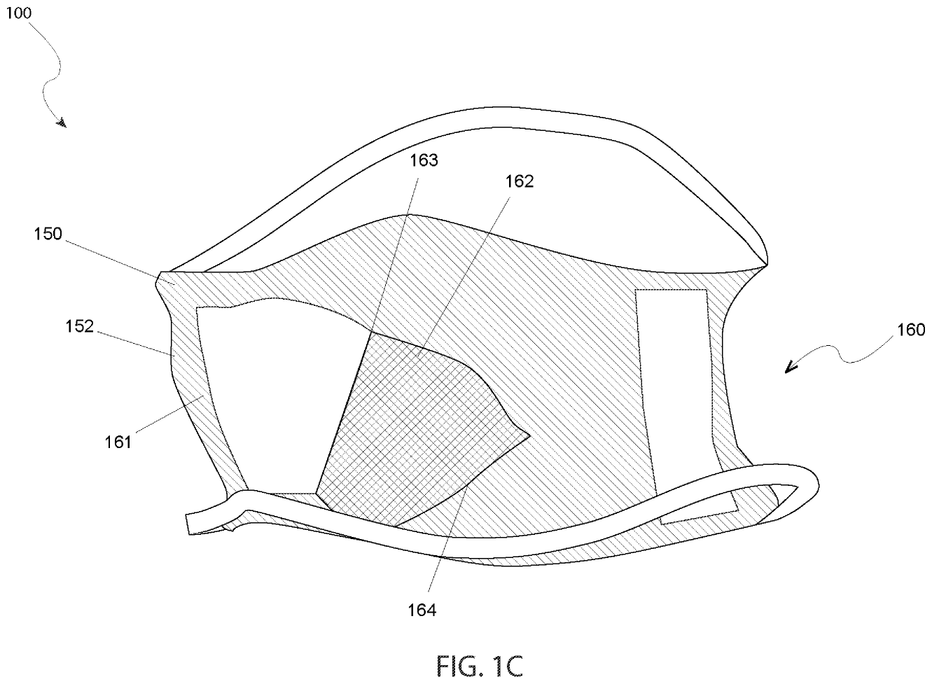

Referring to FIG. 1A and FIG. 1B, an illustrated view of an exemplary improved mask 100 for allowing clearer voice communication is presented, otherwise known as Mask Mic. The mask 100 is useful for providing clearer voice communication when the mask 100 is being worn. Also, the mask 100 is useful preventing the spread of infectious diseases such as COVID. The mask 100 further is light-weight, comfortable and cost efficient.

The mask 100 has a panel 150, and a plurality of first coupling devices 200, 210. The panel 150 of the mask 100 is preferably ten (10) inches in width, however other widths are hereby contemplated, including, but not limited to, eight (8) inches, eleven (11) inches, etc. The panel 150 of the mask 100 is preferably five (5) inches in height, however other heights are hereby contemplated, including, but not limited to, three (3) inches, seven (7) inches, etc. The panel 150 of the mask 100 is preferably made of a quilted cotton material, however other materials are hereby contemplated, including, but not limited to, paper, denim, etc. The plurality of first coupling device 200, 210 are preferably made of an elastic material, however other materials are hereby contemplated, including, but not limited to, cotton, polyester blend, nylon, rubber, etc.

The panel 150 has a first end 151, a second end 152, a top 153, a bottom 154, a front 155 and a back 160.

A first of the first coupling devices 200 is coupled to the first end 151 of the panel 150 preferably by a stitching. A second of the first coupling devices 210 is coupled to the second end 152 of the panel 150 preferably by a stitching. The first of the first coupling devices 200 is coupled to a first ear of a person to secure the mask 100 onto a face of the person. The second of the first coupling devices 210 is coupled to a second ear of the person to further secure the mask 100 to the face of the person.

The front 155 of the panel 150 has a second coupling 156. The second coupling 156 is useful for securing a device, such as a microphone 300 such that the person does not have to remove the mask 100 to be clearly heard when speaking. The microphone 300 is coupled to the second coupling 156 of the front 155 of the panel 150 of the mask 100. The second coupling 156 is preferably a hook and loop fastener, such as a Velcro®-like fastener, however other fasteners are hereby contemplated, including, but not limited to, two-sided tape, a brace, etc.

The microphone 300 is shown in more detail in FIG. 1B. The microphone 300 has a receiving port 301, a central processing unit (CPU) 302, a communications device 303 and a power source 304. The power source 304 is preferably a rechargeable battery, however other types of power sources are hereby contemplated, including, but not limited to, disposable battery, NiCad battery, etc. The communications device 303 preferably sends a signaling protocol compliant with the IEEE 802.15 (Bluetooth®) standards, however other types of signaling protocols are hereby contemplated, including, but not limited to, IEEE 802.11 (WiFi®) protocol standards, 3GPP2 protocol standard, 5G° protocol standards, etc. The CPU 302 receives the voice signals from the person and directs the communications device 303 to send the voice communications via the signaling protocol to an external receiver for playing the voice signals. The communications device is preferably a wireless transmitter.

Moving now to FIG. 1C, an illustrated view of the back 160 of the panel 150 of the improved mask 10 is presented.

A pocket 161 is configured near the second end 152 of the panel 150. A flap 162 is configured to be partially removable from the back 160 of the panel 150 at a first end 163 of the flap 162. The flap 162 is configured to securely cover the pocket 161 when a second end 164 of the flap 162 is coupled to the panel 150, thereby securing any items so stored in the pocket 161. The flap 161 allows access to or closure of the pocket 161.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. An improved mask for allowing clearer voice communication, the mask comprising:
a panel, the panel comprising:
a first end;
a second end;
a top;
a bottom;
a front, the front having a second coupling device, wherein the second coupling device configured to be coupled near the first end of the front of the panel;
a back, the back having a pocket, the pocket being configured near the second end of the back of the panel;
a flap, the flap having a first end and a second end, the first end of the flap being securely coupled to the first end of the pocket, the second end of the flap being removably coupled to the second end of the pocket;
a microphone, the microphone having a receiving device, a CPU, a communications device and a power source, wherein the communications device sends a received voice communication by a signaling protocol before transmittal of the signaling protocol; and
a plurality of first coupling devices, a first of the first coupling devices being coupled to the first end of the panel, and a second of the first coupling devices being coupled to the second end of the panel.

2. The mask of claim 1, wherein the panel has a width of ten (10) inches.

3. The mask of claim 1, wherein the panel has a height of five (5) inches.

4. The mask of claim 1, wherein each of the plurality of first coupling devices is made of an elastic material.

5. The mask of claim 1, wherein the second coupling device is a hook and loop fastener.

6. The mask of claim 1, wherein the signaling protocol of the communications device is consistent with the IEEE 802.15 (Bluetooth®) protocol standards.

7. The mask of claim 1, wherein communications device is a wireless transmitter.

8. The mask of claim 1, wherein panel is made of a quilted cotton material.
